(19) United States
(12) Patent Application Publication
(10) Pub. No.: US 2026/0357140 A1
(43) Pub. Date: Nov. 12, 2026

(54) Method And Device For Continuous Cracking With Integrated Heating Loop

(71) Applicant: BlueAlp Innovations B.V., Eindhoven (NL)

(72) Inventors: Sem HEIJMANS, Eindhoven (NL); Rob BRAAT, Eindhoven (NL); Rik GOLDSMITS, Eindhoven (NL); Teunis Christiaan VAN DER REE, Groot-Ammers (NL)

(73) Assignee: BlueAlp Innovations B.V., Eindhoven (NL)

(21) Appl. No.: 19/134,934

(22) PCT Filed: Dec. 7, 2023
(86) PCT No.: PCT/EP2023/084795

§ 371 Date: Jun. 2, 2025

(30) Foreign Application Priority Data
Dec. 8, 2022 (NL) 2033697

(51) Int. Cl. C10G 9/40; B01J 6/00

(52) U.S. Cl. CPC C10G 9/40; B01J 6/00; C10G 2300/1003

(57) ABSTRACT

The invention provides a device for heating molten long chained hydrocarbons in a continuous process, the device comprising:
a heating fluid circuit having a heat source for heating a heating fluid, and a heating fluid distribution line for circulating the heating fluid;
a first heating section arranged to heat molten long chained hydrocarbons to a first temperature; and
a second heating section arranged to heat molten long chained hydrocarbons to a second temperature;
wherein the first and second heating sections are arranged to receive heating fluid through the heating fluid distribution line; and
wherein the first heating section is arranged to adjust heating fluid circulation through the first heating section in a manner adjusting the first temperature.

### FIELD OF THE INVENTION

The invention generally refers to an apparatus and to a method to process used plastics and polyolefins by means of cracking and more specifically to a structure to heat the plastics and polyolefins to cracking temperatures.

### BACKGROUND OF THE INVENTION

While untreated used plastics have been experienced to pose problems for the environment, they also provide a resource to at least partially replace hydrocarbons usually recovered from crude oil and other fossil fuel sources. When using used plastics as a resource, the known processes very often produce relatively large amounts of soot, that is heavy hydrocarbons and/or solid carbons, which are less sought after, while light hydrocarbons with shorter chain lengths are much more desired in the industry.

WO 2021/053139 A1 thus discloses a method for breaking down long chained hydrocarbons from plastic-containing waste and organic liquids based on crude oil, comprising providing material containing long-chained hydrocarbons; heating a specific volume of the material containing long-chained hydrocarbons to a cracking temperature, at which cracking temperature the chains of hydrocarbons in the material start cracking into shorter chains; and for the specific volume having a temperature above the cracking temperature, exposing the specific volume to heat which is less than or equal to 50 °C above the temperature of the specific volume. In a continuous heating process, the hydrocarbons are conveyed consecutively from a first location at a first temperature to a second location at a higher second temperature and to a third location at a third temperature, higher than the second temperature.

DE 20 2015 009 755 U1 recites a device for processing waste containing plastic and organic liquids based on petroleum, comprising a first heating device, a second heating device, a cracking reactor, and a recycle line, wherein the device is designed to successively heat the plastic recyclables in the first and second heaters and feed them to the cracking reactor, and the recycle stream line from a lower portion of the cracking reactor via a separator system in the supply line for the molten plastic recyclables from the first heating device into the second heating device.

It has further been found that the process sometimes produces more soot in an entire operation cycle than one would expect when considering portions of the operation cycle.

It is an object of the present invention to improve the known methods and systems.

### SUMMARY

While the invention is defined in the independent claims, further aspects of the invention are set forth in the dependent claims, the drawings and the following description.

### BRIEF DESCRIPTION OF THE FIGURES

The figures are not to scale. Like numerals refer to like parts.

FIG. 1 shows an assembly for cracking long chained hydrocarbons;

FIG. 2 shows an embodiment of a heating structure;

FIG. 3 shows an embodiment of a heating section for a heating structure;

FIG. 4 shows an embodiment of a heat transfer structure for a heating structure.

### DESCRIPTION OF THE PREFERRED EMBODIMENTS

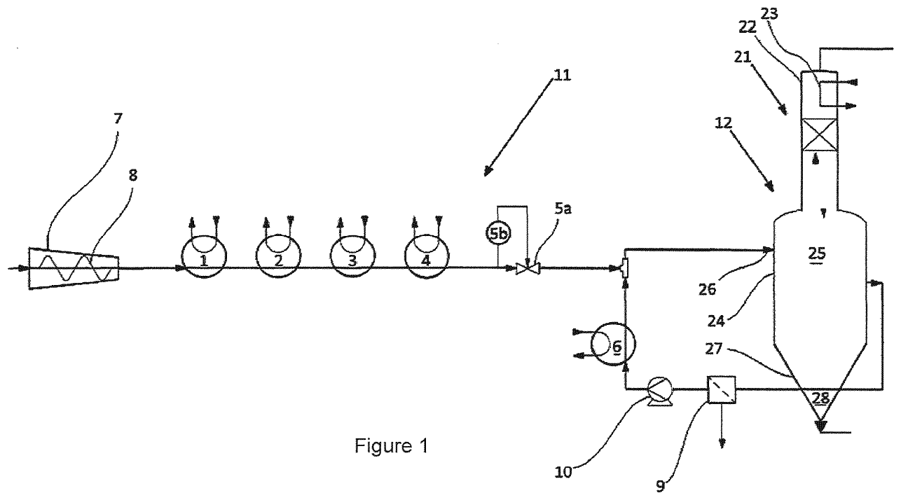

FIG. 1 shows an assembly for cracking long chained hydrocarbons according to an embodiment of the invention. Before further describing details of the depicted embodiment, general aspects of the invention are laid out below.

According to an aspect the invention relates to a device for heating molten long chained hydrocarbons in a continuous process, the device comprising:
a heating fluid circuit having a heat source for heating a heating fluid, and a heating fluid distribution line for circulating the heating fluid;
a first heating section arranged to heat molten long chained hydrocarbons to a first temperature; and
a second heating section arranged to heat molten long chained hydrocarbons to a second temperature;
wherein the first and second heating sections are arranged to receive heating fluid through the heating fluid distribution line; and
wherein the first heating section is arranged to adjust heating fluid circulation through the first heating section in a manner adjusting the first temperature.

By having the first temperature adjusted by adjusting the heating fluid circulation through the heating section, the heat source can operate at a different temperature than the first heating section and can be used for heating sections arranged to heat molten long chained hydrocarbons to different temperatures. In some embodiments the heat source is configured to operate at efficient conditions.

In various embodiments the second heating section is arranged to adjust heating fluid circulation through the second heating section in a manner adjusting the second temperature.

In various embodiments the first and second heating sections are arranged to pass molten long chained hydrocarbons from the first heating section to the second heating section. That is, the first and second heating sections are set up in series for the flow of molten long chained hydrocarbons.

In various embodiments the second temperature is configured above the first temperature.

In various embodiments the second temperature and/or the first temperature are above a cracking temperature of the molten long chained hydrocarbons. In this regard, the cracking temperature is a temperature at which at least some of the molten long chained hydrocarbons start cracking under the conditions in the respective heating section into shorter chains of hydrocarbons. Such conditions are for example a pressure in the respective heating section.

In various embodiments the device comprises a third heating section arranged to heat molten long chained hydrocarbons to a third temperature and to receive heating fluid through the heating fluid distribution line, wherein the molten long chained hydrocarbons are passed from the second heating section to the third heating section, and wherein the third temperature is above the second temperature.

In various embodiments at least one of the heating sections comprises a heat transmission portion and a heating fluid control member, wherein the heat transmission portion is configured to provide heat transmission from the heating fluid to the molten long chained hydrocarbons in the at least one of the heating sections, wherein the heating fluid control member is configured to mix heating fluid from the heat transmission portion and from the heating fluid distribution line to adjust a temperature of the mixed heating fluid and to provide the mixed heating fluid to the heat transmission portion. In this way, any temperature between the temperature of the molten long chained hydrocarbons and the temperature of the heating fluid in the heating fluid distribution line can be adjusted. That is the molten long chained hydrocarbons can selectively be not heated at all if only the heating fluid from the heat transmission portion is recirculated, or it can be heated to the temperature of the heating fluid in the heating fluid distribution line, if only the heating fluid in the heating fluid distribution line is circulated to the heat transmission portion. Also, any temperature therebetween can be adjusted by mixing correspondingly.

In various embodiments the heating fluid control member comprises a fluid control pump to adjust a heating fluid flow through the heat transmission portion and/or a fluid control valve to adjust a share of heating fluid from the heating fluid distribution line in the mixed heating fluid provided to the heat transmission portion. If both, the fluid control pump and the fluid control valve are used, the heating fluid flow can be adjusted separate from the share of heating fluid from the heating fluid distribution line and thus from the temperature of the heat transmission portion.

In various embodiments the device comprises a cooling structure, the cooling structure comprising a heat sink for cooling a heating medium during passage, and a control valve configured to control a share of the heating medium to selectively bypass the heat sink, wherein the heating medium is the heating fluid or a cooling medium. Such cooling structure can effect turn down faster than without such cooling structure and thus allows for shorter downtime for maintenance. In various embodiments the control valve is a split valve or a flow control valve.

According to an aspect, the invention relates to a method for heating molten long chained hydrocarbons in a continuous process, the method comprising:
heating a heating fluid;
circulating the heating fluid;
in a first heating section, heating molten long chained hydrocarbons to a first temperature;
in a second heating section, heating the molten long chained hydrocarbons to a second temperature;
wherein the first and second heating sections are arranged to receive heating fluid through the heating fluid distribution line; and
wherein the first heating section adjusts the heating fluid circulation through the first heating section in a manner adjusting the first temperature.

In various embodiments the second heating section adjusts the heating fluid circulation through the second heating section in a manner adjusting the second temperature, and the molten long chained hydrocarbons pass from the first heating section to the second heating section.

In various embodiments the second temperature is configured above the first temperature, and the second temperature is above a cracking temperature of the molten long chained hydrocarbons.

In various embodiments the first temperature is above a cracking temperature of the molten long chained hydrocarbons.

In various embodiments at least one of the heating sections comprises a heat transmission portion and a heating fluid control member, wherein the heat transmission portion provides heat transmission from the heating fluid to the molten long chained hydrocarbons in the at least one of the heating sections, wherein the heating fluid control member mixes heating fluid from the heat transmission portion and from the heating fluid distribution line to adjust a temperature of the mixed heating fluid and provides the mixed heating fluid to the heat transmission portion.

In various embodiments the molten long chained hydrocarbons are passed from the second heating section to a third heating section, the third heating section receives heating fluid through the heating fluid distribution line and heats the molten long chained hydrocarbons to a third temperature.

In various embodiments the third temperature is above the second temperature.

In various embodiments a cooling structure comprises a heat sink that cools a heating medium during passage, and a split valve that controls a share of the heating medium to selectively bypass the heat sink. The heating medium is the heating fluid or a cooling medium.

In various embodiments a heat transfer structure comprises a primary heat sink that provides a flow path for a process fluid, a secondary heat sink that provides a flow path for a cooling fluid, and a cooling circuit that circulates the cooling medium through the primary heat sink and the secondary heat sink and thus transfers heat from the process fluid at the primary heat sink to the cooling fluid at the secondary heat sink.

In various embodiments the cooling circuit comprises a start-up heating supply that supplies heated cooling medium into the cooling circuit during start-up.

According to another aspect alternative or additional to the aspects listed above a heat transfer structure comprises a primary heat sink providing a flow path for a process fluid in a heating fluid distribution line such as the heating fluid distribution line described above, a secondary heat sink providing a flow path for a cooling fluid, and a cooling circuit for circulating the cooling medium through the primary heat sink and the secondary heat sink to transfer heat from the process fluid at the primary heat sink to the cooling fluid at the secondary heat sink.

In various embodiments the cooling circuit comprises a start-up heating supply configured to supply heated cooling medium into the cooling circuit. By having such cooling circuit between primary and secondary heat sinks, heated cooling medium can be supplied during start-up such that process fluid is not cooled down due to cold cooling medium in the cooling circuit.

In various embodiments the heat transfer structure comprises a cooling medium branch line and a cooling circuit valve. The cooling medium branch line and the cooling circuit valve are configured to control a share of the cooling medium to selectively bypass the secondary heat sink. In various embodiments, the share of the cooling medium bypassing the secondary heat sink is adjusted to adjust the temperature of the cooling medium and/or the process fluid. Particularly, if the share of the cooling medium bypassing the secondary heat sink is increased, less of the cooling medium is cooled in the secondary heat sink and the cooling medium cools down less. Consequently, the process fluid is cooled down less. Particularly, if the share of the cooling medium bypassing the secondary heat sink is decreased, more of the cooling medium is cooled in the secondary heat sink and the cooling medium cools down more. Consequently, the process fluid is cooled down more. In various embodiments the cooling circuit valve is a control valve in the cooling medium branch line and/or in the line before the secondary heat sink, wherein the control valve is configured to adjust the share of the cooling medium to selectively bypass the secondary heat sink. In various embodiments the cooling circuit valve is a split valve splitting the cooling medium to the secondary heat sink and to the cooling medium branch line according to the share of the cooling medium to selectively bypass the secondary heat sink.

Coming back to the description of FIG. 1, the assembly comprises a heating structure 11 and a separation structure 12. The heating structure 11 is in communication with the separation structure 12 to feed fluids into the separation structure 12. Particularly, the heating structure 11 feeds fluids containing cracked hydrocarbons into the separation structure 12.

In some embodiments a feeding device 7 is arranged to fill material containing long chained hydrocarbons such as waste plastic or crude oil into the heating structure 11. In various embodiments the feeding device comprises a component for storing and/or a component for breaking up any solid material exceeding a predetermined size. In some embodiments the predetermined size is around 100 mm or around 50 mm. In further embodiments the predetermined size is between 15 mm and 50 mm. In further embodiments, the predetermined size is between 2 mm and 15 mm. In some embodiments the feeding device comprises an effector 8 for heating and/or forwarding the material containing long chained hydrocarbons. In some embodiments the effector is a screw auger 8 arranged to heat and/or forward the material containing long chained hydrocarbons. In some embodiments the screw auger moves 8 the material and internal friction in the material causes the material to heat up and to melt. In further embodiments the feeding device 7 comprises a heating device such as an electrical heater or a heating device perfused by a heating medium such as thermal oil. In various embodiments heating causes water to evaporate. In various embodiments the feeding device 7 comprises a pump such as a liquid ring pump to remove the water and/or halogens via degassing. The feeding device 7 forwards the material containing long chained hydrocarbons to the heating structure 11.

The heating structure 11 receives the material containing long chained hydrocarbons. In various embodiments the heating structure comprises at least one heating zone 1, 2, 3, 4. The heating zone 1, 2, 3, 4 is arranged to expose the material containing long chained hydrocarbons to a limited temperature increase. Said differently, the material containing long chained hydrocarbons is exposed to a temperature that is less than a predetermined temperature above the temperature of the material. It has been found that by limiting a temperature increase, a yield of usable material containing hydrocarbons having desired chain lengths resulting from the operation of the assembly is increased, and the amount of resulting solid carbons is limited. In various embodiments, the heating zone 1, 2, 3, 4 is arranged to expose the material containing long chained hydrocarbons to a predetermined temperature of around 50 °C or less above the temperature of the material containing long chained hydrocarbons in a respective section of the heating zone 1, 2, 3, 4.

In the following, the temperature to which the material containing long chained hydrocarbons is exposed will be referred to as exposure temperature. The exposure temperature will have different values depending on the location in the assembly and the corresponding temperature of the material containing long chained hydrocarbons.

For example, for the material containing long chained hydrocarbons entering the heating zone 1, 2, 3, 4 and having a temperature of around 200 °C, the heating zone 1, 2, 3, 4 exposes the material containing long chained hydrocarbons at the entrance of the heating zone 1, 2, 3, 4 to an exposure temperature of 250 °C or less. Once the material containing long chained hydrocarbons starts heating up, the heating zone 1, 2, 3, 4 exposes the material to exposure temperatures increased accordingly. For example, when the material containing long chained hydrocarbons has heated to a temperature of 250 °C, the heating zone 1, 2, 3, 4, exposes the material to an exposure temperature of up to 300 °C.

In various embodiments the heating zone 1, 2, 3, 4 provides a flow path for the material containing long chained hydrocarbons. The heating zone 1, 2, 3, 4 continuously or gradually increases the exposure temperature along the flow path. In some embodiments, the heating zone 1, 2, 3, 4 provides at least one first tube for the material containing long chained hydrocarbons. The material generally flows through the at least one first tube in a first direction. The heating zone 1, 2, 3, 4 further provides at least one second tube contacting the first tube along a substantial length of the heating zone 1, 2, 3, 4 such that heat can transfer from the inside of the at least one second tube into the first tube. The second at least one tube provides a flow path for a heating medium.

In some of these embodiments the heating medium is controlled to have a temperature not more than 50 °C above a predetermined final temperature when entering the second at least one tube along the heating zone 1, 2, 3, 4, and to have a temperature not more than 50 °C above a temperature of the material containing long chained hydrocarbons when entering the heating zone 1, 2, 3, 4. In some embodiments temperature, velocity and/or pressure of the heating medium in the second at least one tube and/or the material containing long chained hydrocarbons in the first at least one tube are controlled. In some embodiments the second at least one tube is dimensioned such that the heating medium flowing at a predetermined velocity therethrough and having a predetermined starting velocity will have the predetermined temperature characteristics.

In some embodiments the heating zone 1, 2, 3, 4 comprises several heating sections, each heating section exposing the material containing long chained hydrocarbons to a predetermined temperature. The heating sections are configured such that the material containing long chained hydrocarbons flows consecutively through each of them. Each heating section exposes the material to a higher exposure temperature than a previous heating section. The heating sections are configured such that the exposure temperatures do not exceed 50 °C above the temperature of the material containing long chained hydrocarbons when entering the respective heating section.

In the embodiment of FIG. 1 the heating zone 1, 2, 3, 4 comprises four heating sections. For example, for the material containing long chained hydrocarbons entering a first heating section 1 and having a temperature of around 200 °C, the heating section 1 exposes the material containing long chained hydrocarbons to a first exposure temperature of 250 °C or less. While the material containing long chained hydrocarbons flows through the first heating section 1, the material containing long chained hydrocarbons heats up and its temperature approaches the first exposure temperature. In some embodiments the first exposure temperature is between 200 °C and 370 °C. In some embodiments the first exposure temperature is between 220 °C and 320 °C. In some embodiments the first exposure temperature is about 250 °C.

Whether cracking takes place inside the first heating section 1 depends, apart from the temperature, on the long-chained hydrocarbons contained in the material as well as other substances contained deliberately or incidentally in the material, and the pressure of the material. In some cases, cracking substantially does not take place at low temperatures such as between 200 °C and 250 °C as the further parameters do not promote cracking. In such cases the exposure temperature may be higher than 50 °C above the temperature of the material. In some embodiments the exposure temperature may be as high as 50 °C above the minimum temperature at which cracking substantially takes place.

When exiting the first heating section 1, the material passes to a second heating section 2 downstream of the first heating section 1. The second heating section 2 exposes the material containing long chained hydrocarbons to a higher exposure temperature than the first heating section 1, namely a second exposure temperature. The second exposure temperature does not exceed a temperature of 50 °C above the temperature of the material containing long chained hydrocarbons. In various embodiments the second exposure temperature is between 250 °C and 400 °C. In some embodiments the second exposure temperature is between 270 °C and 370 °C. In some embodiments the second exposure temperature is at about 300 °C. The material containing long chained hydrocarbons flows through the second heating section 2 and heats up towards the second exposure temperature.

From the second heating section 2 the material containing long chained hydrocarbons passes to a third heating section 3 downstream of the second heating section 2. The third heating section 3 exposes the material to a third exposure temperature. The third exposure temperature is higher than the second exposure temperature. The third exposure temperature does not exceed a temperature of 50 °C above the temperature of the material. In various embodiments the third exposure temperature is between 300 °C and 400 °C. In some embodiments the third exposure temperature is between 320 °C and 380 °C. In some embodiments the third exposure temperature is about 370 °C. The material containing long chained hydrocarbons flows through the third heating section 3 and heats up towards the third exposure temperature.

From the third heating section 3 the material containing long chained hydrocarbons passes to a fourth heating section 4 downstream of the third heating section 3. The fourth heating section 4 exposes the material to a fourth exposure temperature. The fourth exposure temperature does not exceed a temperature of 50 °C above the temperature of the material. The fourth exposure temperature essentially determines the maximum temperature for cracking of the long chained hydrocarbons. In some embodiments the fourth exposure temperature is between 350 °C and 450 °C. In further embodiments, the fourth exposure temperature is between 380 °C and 420 °C. The material containing long chained hydrocarbons flows through the fourth heating section 4 and heats up towards the fourth exposure temperature.

While the material containing long chained hydrocarbons flows through the fourth heating section 4, some of the long chained hydrocarbons are cracked. In some embodiments, some of the long chained hydrocarbons are cracked while the material flows through the third heating section 3. In some embodiments, some of the long chained hydrocarbons are cracked while the material flows through the second heating section 2. In some embodiments, some of the long chained hydrocarbons are cracked while the material flows through the first heating section 1. Principally the hotter a heating section is, the more cracking takes place. Once substantial amounts of long chained hydrocarbons are being cracked, the heating section limits the exposure temperature to a maximum of 50 °C above the temperature of the material. The material containing long chained hydrocarbons thus also contains cracked hydrocarbons. That is, a share of the hydrocarbons with shorter chain lengths is increased as compared to the material before entering the heating zone. The material exiting the fourth heating section 4 is passed to the separation structure 12.

In various embodiments the heating sections are comprised of identical structures such that only one type of heating section can be used for each position in the chain of heating sections. In various embodiments the heating sections are designed for heating up to a temperature of 450 °C. In various embodiments the heating sections are designed for operational pressures between 0 bar and 80 bar. In various embodiments the heating sections are supplied with a thermal oil as a heating medium. In various embodiments the thermal oil is selected to have a boiling point above the operating temperatures of the heating sections and/or a solidification temperature below 40 °C.

For a heating structure having more or less heating sections the above applies correspondingly.

In some embodiments there is a back pressure control element 5a, 5b downstream of the heating zone 1, 2, 3, 4. The back pressure control element 5a, 5b is arranged to adjust a pressure of the material containing long chained hydrocarbons in the heating zone. In various embodiments the back pressure control element controls a throughput of the material through the heating zone. The back pressure control element is arranged between the heating zone and the separation structure 12. The material containing long chained hydrocarbons exiting the back pressure control element 5a, 5b is passed to the separation structure 12. In some embodiments the back pressure control element comprises an adjustable valve 5a and a pressure sensor 5b. The pressure sensor 5b is configured to detect a pressure of the material in the heating zone. The adjustable valve 5a is configured to release the material as long as the pressure sensor 5b detects a pressure in a specific range. In some embodiments the specific range is between 10 bar and 40 bar. In some embodiments the specific range is at around 20 bar. If the material in the heating zone has a pressure outside the range, the valve 5a controls a throughput of material. For example, if the pressure in the heating zone drops below a lower boundary of the pressure range, the valve 5a reduces a throughput until pressure in the heating zone builds up. If the pressure in the heating zone exceeds an upper boundary, the valve 5a allows for an increased throughput until the pressure drops. In some embodiments the valve 5a has a structure of a pressure relief valve, that is, the valve 5a is kept closed by a preloaded spring and opens towards the following separation structure 12 once a predetermined pressure is exceeded, while it closes once the pressure drops below a predetermined pressure. In further embodiments the valve 5a is a gate valve opening and closing to adjust a throughput and thereby the pressure as detected by the pressure sensor 5b. In some embodiments the valve 5a is arranged to allow a small throughput at all times, said differently, the valve 5a is arranged to not be fully closed.

Once the material has passed the back pressure control element, the pressure in the material drops. Particularly shorter chained hydrocarbons resulting from cracking evaporate into a gas phase resulting in a gas containing hydrocarbons.

The material with the liquid and the gas containing hydrocarbons is passed to the separation structure 12. In the separation structure 12, the gas containing hydrocarbons separates from the liquid containing longer chains of hydrocarbons of the material. The gas containing hydrocarbons rises from the liquid. The separation structure 12 releases gas containing hydrocarbons with a chain length equal to or less than a predetermined chain length. In some embodiments the separation structure 12 comprises a gas release at its top portion. The gas release preferably is equipped with a partial condenser 21.

In various embodiments the separation structure 12 comprises a partial condenser 21, a separation zone 25 containing a gas-liquid interface of the hydrocarbon material, and a setting zone 28 for heavy hydrocarbons and/or solid carbon to accumulate. In some embodiments the separation structure 12 comprises a cylinder shaped intermediate portion 24 containing the separation zone 25, and a funnel shaped bottom portion 27 containing the setting zone 28 with the funnel ending in an outlet for the heavy hydrocarbons and/or solid carbons.

The partial condenser 21 is configured to allow gas having hydrocarbons with a maximum chain length to pass. The partial condenser 21 cools the gas containing hydrocarbons to a condensation temperature that causes hydrocarbons of a certain chain length and above to condense. The partial condenser circulates condensed hydrocarbons back towards the liquid. In some embodiments the condensation temperature is between 270 °C and 370 °C. In further embodiments the condensation temperature is 320 °C.

In some embodiments the partial condenser 21 comprises a condenser vessel 22 providing a flow path for the gas containing hydrocarbons and a cooling tube 23 for a cooling medium such as thermal oil to cool the gas. In some embodiments the cooling tube 23 intersects the condenser vessel 22. In some embodiments the cooling tube extends in meanders, spirals and/or helically inside the condenser vessel 22. In some embodiments the condenser vessel 22 and the cooling tube 23 are configured such that the gas flows in both, in a vertical direction and in one or more horizontal directions. Said differently, the gas cannot pass the partial condenser 21 in a straight line. In some embodiments the cooling tube 23 provides cooling ribs and/or baffles increasing a contact surface with the gas and particularly guiding and/or retarding the gas flow inside the partial condenser 21. In some embodiments the partial condenser 21 comprises a random arrangement of cooling ribs and/or baffles.

The partial condenser 21 is thus arranged to pass gas containing hydrocarbons having chain lengths including or below the predetermined chain length. In some embodiments the predetermined chain length is 30 carbons. In further embodiments the predetermined chain length is 25 carbons. In further embodiments the predetermined chain length is 22 or 20 carbons. Hydrocarbons having a chain length above the predetermined chain length are circulated back into the liquid in the separation structure 12.

In various embodiments the separation structure 12 releases the liquid containing hydrocarbons with a chain length longer than the predetermined chain length. The separation structure 12 removes heavy hydrocarbons and/or solid carbon resulting from cracking.

In some embodiments the heating structure 11 comprises a reheating zone 6. The liquid containing hydrocarbons is piped from the separation structure 12 through the reheating zone 6. The reheating zone 6 heats the liquid containing hydrocarbons again such that further long chained hydrocarbons are cracked. In some embodiments the reheating zone is arranged to provide an exposure temperature of not more than 50 °C above the temperature of the liquid containing hydrocarbons. The limited exposure temperature may limit carbonization of the hydrocarbons. In some embodiments the reheating zone 6 is arranged to at least partially account for the heat loss of the material in the separation structure 12 due to the separation of gas and carbons, as well as heat loss through the wall of the separation structure 12 and any pipelines. In some embodiments the reheating zone 6 provides an exposure temperature of between 380 °C and 450 °C. In further embodiments the reheating zone 6 provides an exposure temperature of between 390 °C and 440 °C, preferably between 405 °C and 430 °C.

In some embodiments the liquid containing hydrocarbons passes a filter 9 to remove particles. In some embodiments the liquid containing hydrocarbons is forwarded by means of a pump 10 arranged to adjust a flow rate of the liquid.

The liquid exits the reheating zone 6 and evaporates gas of cracked hydrocarbon chains. In some embodiments the liquid in the reheating zone 6 is not pressurized such that some of the cracked hydrocarbons evaporates into gas of cracked hydrocarbon chains in the reheating zone 6 already. In some embodiments the liquid and/or gas exiting the reheating zone 6 is feed into the separation structure 12 to release the evaporated gas. In some embodiments the liquid and/or gas exiting the reheating zone 6 is mixed with the material exiting the heating zone 1, 2, 3, 4. In some embodiments the liquid and/or gas exiting the reheating zone 6 is mixed with the material exiting the back pressure control element 5a, 5b. In some embodiments a mixing ratio of liquid and/or gas exiting the reheating zone 6 to material exiting the heating zone 1, 2, 3, 4 is between 5:1 and 15:1 by flow rate, more preferably between 8:1 and 10:1 by flow rate. In some embodiments the mixing ratio is adjusted by the feeding device 7, the heating zone, the back pressure control element and the pump 10. In some embodiments the reheating zone 6 is supplied with thermal oil such as the thermal oil used in the first to fourth heating sections 1, 2, 3, 4. In some embodiments the reheating zone 6 receives thermal oil of the same temperature as the fourth heating zone 4.

In some embodiments, the reheating zone 6 adjusts a temperature of the material dependent on a volume of the material inside the separation structure 12. In some embodiments the reheating zone adjusts a temperature of the material to adjust a cracking rate of the material. In some embodiments the cracking rate is a measure for cracking events per time frame. In further embodiments the cracking rate is a measure of cracking events per volume. By adjusting the cracking rate, the amount of short chained hydrocarbons in the material is adjusted which in turn adjusts evaporation of the material, as cracked hydrocarbons generally have a lower evaporation temperature than the same hydrocarbons before cracking. Further, by heating the material, more material evaporates. Accordingly, by increasing the temperature of the material, evaporation in the material is promoted and the volume of the material in the liquid state decreases. In some embodiments this is used to adjust the level of the material in the liquid state inside the separation structure 12.

In an exemplary embodiment, the heating sections 1, 2, 3, 4, the reheating zone 6 and the thermal oil used provide the following parameters:

Operating temperatures heat exchangers

| | heating | heating | heating | heating | reheating |
|---|---|---|---|---|---|
| | section 1 | section 2 | section 3 | section 4 | zone 6 |
| PM Inlet | 250-300 | 295-350 | 330-370 | 368-390 | 395 . . . 420 |
| Temp °C | | | | | |
| PM Outlet | 300-350 | 333-370 | 368-390 | 398-390 | 415 . . . 430 |
| Temp °C | | | | | |
| TO Inlet | 313-360 | 350-375 | 380-395 | 393-410 | 415 . . . 430 |
| Temp °C | | | | | |
| TO Outlet | 300-344 | 340-370 | 374-389 | 400-395 | 410 . . . 425 |
| Temp °C | | | | | |

where “PM Inlet Temp” designates the temperature of the material containing long chained hydrocarbons when input into the respective heating section, “PM Outlet Temp” designates the temperature of the material containing long chained hydrocarbons when output from the respective heating section, “TO Inlet Temp” designates the temperature of the thermal oil used as a heating medium in this exemplary embodiment when applied to the respective heating section and “TO Outlet Temp” designates the temperature of the thermal oil after application in the respective heating zone. As can be seen in this table, a maximum difference between TO Inlet Temp and PM Outlet Temp as well as between TO Outlet Temp and PM Inlet Temp does not exceed 50 °C. As the thermal oil flows in a direction opposite to a flow direction of the material through the respective heating section, the exposure temperatures do not exceed 50 °C above the temperature of the material.

In various embodiments the material containing hydrocarbons comes from the heating structure 11 and enters the separation structure 12 through an inlet 26. Heavy hydrocarbons and/or solid carbons decelerate and sink towards the bottom. In various embodiments, the heavy hydrocarbons and solid carbons accumulate in the setting zone 28. In some embodiments the funnel shaped bottom portion 27 guides the heavy hydrocarbons and solid carbons to the outlet for the heavy hydrocarbons and/or solid carbons.

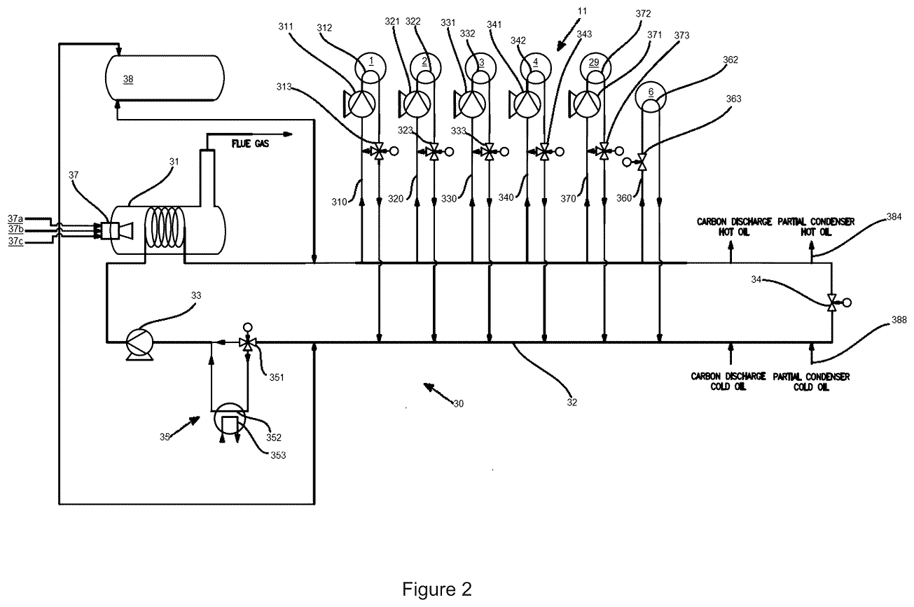

FIG. 2 shows an embodiment of the heating structure 11 in more detail. The heating structure 11 in the depicted embodiment is shown with the first to fourth heating sections 1, 2, 3, 4, with the reheating zone 6 and with a reboiler section 29. The reboiler section 29 is configured to adjust a temperature of liquid condensed from gas having passed the partial condenser 21. The heating structure 11 further comprises a heating fluid circuit 30 having a heat source 31, a heating fluid distribution line 32, a distribution line pump 33 for circulating heating fluid and a choke valve 34. The heating fluid circuit 30 is configured to circulate a heating fluid as the heating medium through the heating fluid distribution line 32 to heat at least one of the first to fourth heating sections 1, 2, 3, 4.

In various embodiments the heating fluid distribution line 32 is configured to provide heating fluid from one heat source 31 to at least two of the first to fourth heating sections 1, 2, 3, 4, the reboiler section 29 and the reheating zone 6. In further embodiments the heating fluid distribution line 32 is configured to provide heating fluid from one heat source 31 to all of the first to fourth heating sections 1, 2, 3, 4. In further embodiments the heating fluid distribution line 32 is configured to provide heating fluid from one heat source 32 to all of the first to fourth heating sections 1, 2, 3, 4, to the reheating zone 6 and to the reboiler section 29. In various embodiments, the heating fluid circuit 30 comprises at least two heat sources.

In various embodiments the heat source 31 is a flare 37 configured for burning gas to heat the heating medium in the heating fluid distribution line 32. In some embodiments the gas for the flare 37 is incondensable gas 37a produced in the cracking process. In some embodiments the gas for the flare 37 is natural gas 37b. In some embodiments the flare 37 comprises an oxygen source 37c. In further embodiments the heat source 31 is a heat pump. In further embodiments the heat pump uses exhaust heat from portions of the assembly for cracking long chained hydrocarbons downstream of the separation structure 12 to heat the heating medium. In further embodiments the heat pump and the flare 37 are combined as heat sources in one heating fluid circuit 30. In such embodiments the heat pump may use exhaust heat from flue gas of the flare 37.

In various embodiments the choke valve 34 is configured to adjust a differential pressure across portions of the heating fluid distribution line 32.

In various embodiments the heating structure 11 further comprises an expansion vessel 38 allowing heating fluid to expand and contract.

In various embodiments the heating structure 11 comprises a cooling branch 35 arranged to selectively cool the heating fluid. The cooling branch 35 comprises a cooling branch split valve 351 and a heat sink portion 352. The cooling branch split valve 351 is configured to divert adjustable amounts of heating fluid from the heating fluid distribution line 32 along the heat sink portion 352 to thus reduce a temperature of heating fluid in the heating fluid distribution line 32 by an adjustable amount. In various embodiments the heat sink portion 352 provides a flow path for the heating fluid and a flow path for cooling fluid 353 with the flow path for heating fluid and the flow path for cooling fluid 353 contacting each other in a manner promoting heat transfer from the heating fluid to the cooling fluid. In various embodiments the cooling fluid is water or a fluid containing water. In further embodiments the cooling fluid is selected to have a phase change from liquid to gas when heat is transferred from the heating fluid to the cooling fluid.

Each of the first to fourth heating sections 1, 2, 3, 4 comprises first to fourth branch lines 310, 320, 330, 340, respectively, configured to pass heating fluid from the heating fluid distribution line 32 through the first to fourth heating sections 1, 2, 3, 4 and back into the heating fluid distribution line 32.

The first heating section 1 further comprises a first heat transmission portion 312 and a first heating fluid control member 311, 313. The first branch line 310 is configured to pass heating fluid through the first heat transmission portion 312. The first heat transmission portion 312 is configured to provide heat transmission from the heating fluid to the molten long chained hydrocarbons in the first heating section 1. The first heating fluid control member 311, 313 is configured to adjust a flow rate of the heating fluid through the first heat transmission portion 312. In various embodiments the first heating fluid control member 311, 313 is configured to adjust the flow rate of the heating fluid through the first heat transmission portion 312 to adjust a temperature of the molten long chained hydrocarbons at the first heating section 1. In various embodiments, the first heating fluid control member comprises a first fluid control pump 311 and/or a first fluid control valve 313. In various embodiments, the first fluid control pump 311 is arranged to adjust a throughput of the heating fluid through the first heating section 1. In various embodiments, the first fluid control valve 313 is arranged to adjust a throughput of the heating fluid through the first heating section 1. In various embodiments, the first fluid control valve 313 is arranged to split the flow of heating fluid to either pass the first heating section 1 or to bypass the first heating section 1. In further embodiments the first fluid control valve 313 is arranged to adjust a recirculation of heating fluid after passing the first heating section 1 in a manner that at least some of the heating fluid passes to the first fluid control pump 311 and the first heating section 1 without first passing to the heating fluid distribution line 32 and the heat source 31.

As the temperature at the first heating section is adjusted by adjusting shares of the heating fluid from the heating fluid distribution line 32 and recirculated heating fluid from the first heating section 1, the exposure temperature at the first heat transmission portion 312 is adjusted without requiring a specific heat source for this temperature.

The second heating section 2 further comprises a second heat transmission portion 322 and a second heating fluid control member 321, 323. The second branch line 320 is configured to pass heating fluid through the second heat transmission portion 322. The second heat transmission portion 322 is configured to provide heat transmission from the heating fluid to the molten long chained hydrocarbons in the second heating section 2. The second heating fluid control member 321, 323 is configured to adjust a flow rate of the heating fluid through the second heat transmission portion 322. In various embodiments the second heating fluid control member 321, 323 is configured to adjust the flow rate of the heating fluid through the second heat transmission portion 322 to adjust a temperature of the molten long chained hydrocarbons at the second heating section 2. In various embodiments, the second heating fluid control member comprises a second fluid control pump 321 and/or a second fluid control valve 323. In various embodiments, the second fluid control pump 321 is arranged to adjust a throughput of the heating fluid through the second heating section 2. In various embodiments, the second fluid control valve 323 is arranged to adjust a throughput of the heating fluid through the second heating section 2. In various embodiments, the second fluid control valve 323 is arranged to split the flow of heating fluid to either pass through the second heating section 2 or to bypass the second heating section 2. In further embodiments the second fluid control valve 323 is arranged to adjust a recirculation of heating fluid after passing the second heating section 2 in a manner that at least some of the heating fluid passes to the second fluid control pump 321 and the second heating section 2 without first passing to the heating fluid distribution line 32 and the heat source 31.

The third heating section 3 further comprises a third heat transmission portion 332 and a third heating fluid control member 331, 333. The third branch line 330 is configured to pass heating fluid through the third heat transmission portion 332. The third heat transmission portion 332 is configured to provide heat transmission from the heating fluid to the molten long chained hydrocarbons in the third heating section 3. The third heating fluid control member 331, 333 is configured to adjust a flow rate of the heating fluid through the third heat transmission portion 332. In various embodiments the third heating fluid control member 331, 333 is configured to adjust the flow rate of the heating fluid through the third heat transmission portion 332 to adjust a temperature of the molten long chained hydrocarbons at the third heating section 3. In various embodiments, the third heating fluid control member comprises a third fluid control pump 331 and/or a third fluid control valve 333. In various embodiments, the third fluid control pump 331 is arranged to adjust a throughput of the heating fluid through the third heating section 3. In various embodiments, the third fluid control valve 333 is arranged to adjust a throughput of the heating fluid through the third heating section 3. In various embodiments, the third fluid control valve 333 is arranged to split the flow of heating fluid to either pass through the third heating section 3 or to bypass the third heating section 3. In further embodiments the third fluid control valve 333 is arranged to adjust a recirculation of heating fluid after passing the third heating section 3 in a manner that at least some of the heating fluid passes to the third fluid control pump 331 and the third heating section 3 without first passing to the heating fluid distribution line 32 and the heat source 31.

The fourth heating section 4 further comprises a fourth heat transmission portion 342 and a fourth heating fluid control member 341, 343. The fourth branch line 340 is configured to pass heating fluid through the fourth heat transmission portion 342. The fourth heat transmission portion 342 is configured to provide heat transmission from the heating fluid to the molten long chained hydrocarbons in the fourth heating section 4. The fourth heating fluid control member 341, 343 is configured to adjust a flow rate of the heating fluid through the fourth heat transmission portion 342. In various embodiments the fourth heating fluid control member 341, 343 is configured to adjust the flow rate of the heating fluid through the fourth heat transmission portion 342 to adjust a temperature of the molten long chained hydrocarbons at the fourth heating section 4. In various embodiments, the fourth heating fluid control member comprises a fourth fluid control pump 341 and/or a fourth fluid control valve 343. In various embodiments, the fourth fluid control pump 341 is arranged to adjust a throughput of the heating fluid through the fourth heating section 4. In various embodiments, the fourth fluid control valve 343 is arranged to adjust a throughput of the heating fluid through the fourth heating section 4. In various embodiments, the fourth fluid control valve 343 is arranged to split the flow of heating fluid to either pass through the fourth heating section 4 or to bypass the fourth heating section 4. In further embodiments the fourth fluid control valve 343 is arranged to adjust a recirculation of heating fluid after passing the fourth heating section 4 in a manner that at least some of the heating fluid passes to the fourth fluid control pump 341 and the fourth heating section 4 without first passing to the heating fluid distribution line 32 and the heat source 31.

In some embodiments the reheating zone 6 comprises a reheating branch line 360, a reheating heat transmission portion 362 and a reheating fluid control member 363. The reheating branch line 360 is configured to pass heating fluid through the reheating heat transmission portion 362. The reheating heat transmission portion 362 is configured to provide heat transmission from the heating fluid to the molten long chained hydrocarbons in the reheating zone 6 piped from the separation structure 12. The reheating fluid control member 363 is configured to adjust a flow rate of the heating fluid through the reheating heat transmission portion 362. In various embodiments, the reheating fluid control member comprises a reheating fluid control valve 363. In various embodiments, the reheating fluid control valve 363 is arranged to adjust a throughput of the heating fluid through the reheating zone 6. In various embodiments the temperature of the reheating heat transmission portion 362 of the reheating zone 6 corresponds to the temperature of the heating fluid adjusted by the heat source 31 and as distributed in the heating fluid distribution line 32.

In various embodiments the reboiler section 29 comprises a reboiler branch line 370, a reboiler heat transmission portion 372 and a reboiler heating fluid control member 371, 373. The reboiler branch line 370 is configured to pass heating fluid through the reboiler heat transmission portion 372. The reboiler heat transmission portion 372 is configured to provide heat transmission from the heating fluid to gas coming from the partial condenser 21. The reboiler heating fluid control member 371, 373 is configured to adjust a flow rate of the heating fluid through the reboiler heat transmission portion 372. In various embodiments the reboiler heating fluid control member 371, 373 is configured to adjust the flow rate of the heating fluid through the reboiler heat transmission portion 372 to adjust a temperature of the gas coming from the partial condenser 21. In various embodiments, the reboiler heating fluid control member comprises a reboiler fluid control pump 371 and/or a reboiler fluid control valve 373. In various embodiments, the reboiler fluid control pump 371 is arranged to adjust a throughput of the heating fluid through the reboiler section 29. In various embodiments, the reboiler fluid control valve 373 is arranged to adjust a throughput of the heating fluid through the reboiler section 29. In various embodiments, the reboiler fluid control valve 373 is arranged to split the flow of heating fluid to either pass through the reboiler section 29 or to bypass the reboiler section 29. In further embodiments the reboiler fluid control valve 373 is arranged to adjust a recirculation of heating fluid after passing the reboiler section 29 in a manner that at least some of the heating fluid passes to the reboiler fluid control pump 371 and the reboiler section 29 without first passing to the heating fluid distribution line 32 and the heat source 31.

Each of the first to fourth heating sections 1, 2, 3, 4 and the reboiler section 29 thus comprise both the first to fourth and reboiler fluid control pumps 311, 321, 331, 341, 371 and the first to fourth and reboiler fluid control valves 313, 323, 333, 343, 371 to adjust circulation of heating fluid through the respective first to fourth heating sections 1, 2, 3, 4 and the reboiler section 29.

As the temperatures at the first to fourth heating sections 1, 2, 3, 4 and the reboiler section 29 are adjusted by adjusting respective shares of the heating fluid from the heating fluid distribution line 32 and recirculated heating fluid from the first to fourth heating and reboiler sections 1, 2, 3, 4, 29 the respective exposure temperatures at the first to fourth and reboiler heat transmission portions 312, 322, 332, 342, 372 are adjusted without requiring a specific heat source for each of these temperatures. Rather, several different temperatures can be adjusted while the heat source 31 operates at optimal conditions. Also during start up, the heat source 31 can operate at optimal conditions while the first to fourth heating sections 1, 2, 3, 4 can be heated gradually. This increases a yield of usable material containing hydrocarbons having desired chain lengths resulting from the operation of the assembly during start-up, and the amount of resulting solid carbons is limited. This also avoids built-up of solids at the respective heat transmission portions. This latter is particularly desirable, as the start-up particularly follows maintenance and thus cleaning of the heat transmission portions. It is undesirable to have the recently cleaned heat transmission portions covered in caked solid material right from start-up.

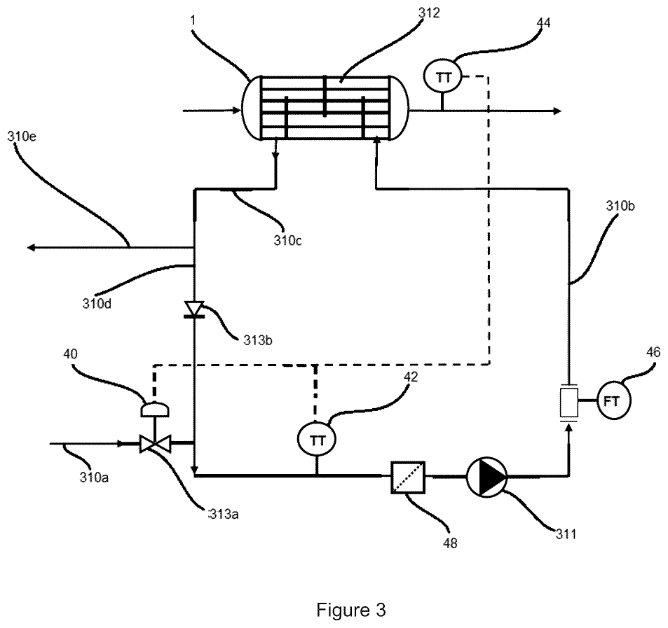

FIG. 3 shows the first heating section 1 and the first branch line 310 as an example. In various embodiments, the example of FIG. 3 is likewise applicable to the second to fourth and reboiler heating sections 1, 2, 3, 4, 29, and the respective branch lines, wherein parameters are adapted accordingly. The first heating section 1 thus comprises the first fluid control pump 311 and in the depicted embodiment the first fluid control valve 313 is arranged as a combination of an adjustable flow control valve 313a and a check valve 313b. In normal conditions, the flow of the first fluid control pump 311 is adjusted in a way that the temperature of the heating fluid and thus the exposure temperature is limited as specified above. Generally, if the first fluid control pump 311 does not operate but block passage of heating fluid, the heating fluid will approach the temperature of the molten long chained hydrocarbons entering the heating section 1. Likewise, if the flow control valve 313a is closed, the heating fluid will approach the temperature of the molten long chained hydrocarbons entering the heating section 1.

In various embodiments the first heating section 1 comprises a flow control member 40, a medium temperature sensor 42 and a material temperature sensor 44. In various embodiments the first branch line 310 comprises a flow control line section 310a, a temperature adjusted line section 310b, a recover line section 310c, a bypass line section 310d and a return line section 310e. The flow control line 310a is provided with the flow control member 40 and joins with the bypass line section 310d into the temperature adjusted line section 310b. The temperature adjusted line section 310b is provided with the first fluid control pump 311 and leads to the first heat transmission portion 312 such that any fluid passing the temperature adjusted line section passes to the first heat transmission portion 312. The recover line section 310c leads from the first heat transmission portion 312 and splits into the bypass line section 310d and the return line section 310e. The bypass line section 310d is provided with the check valve 313b preventing fluid from passing from the flow control line 310a to the return line section 310e without passing the first heat transmission portion 312.

The medium temperature sensor 42 is arranged at the temperature adjusted line section 310b and is configured to measure a temperature of the heating medium such as the heating fluid in the temperature adjusted line section 310b, and to transmit a signal representative of the temperature of the heating medium to the flow control member 40. In some embodiments the medium temperature sensor 42 is configured to measure the temperature of the heating medium prior to the heating medium passing the first heat transmission portion 312. In some embodiments the medium temperature sensor 42 is configured to measure the temperature of the heating medium after the heating medium passing the first heat transmission portion 312. In various embodiments the medium temperature sensor 42 is configured to measure the temperature of the heating medium prior to and after the heating medium passing the first heat transmission portion 312. In some of these embodiments the medium temperature sensor 42 determines a temperature difference of the heating medium from before passing the heat exchanger 1 and after passing the first heat transmission portion 312. In some of these embodiments the medium temperature sensor 42 is configured to transmit a signal representative of the temperature of the heating medium from before passing the first heat transmission portion 312 and after passing the first heat transmission portion 312, and/or the temperature difference of the heating medium before and after passing the first heat transmission portion 312.

The material temperature sensor 44 is configured to measure a temperature of the material containing long chained hydrocarbons and to transmit a signal representative of the temperature of the material containing long chained hydrocarbons to the flow control member 40. In various embodiments the material temperature sensor 44 is configured to measure a temperature of the material containing long chained hydrocarbons prior to the material containing long chained hydrocarbons passing the first heat transmission portion 312. In various embodiments the material temperature sensor 44 is configured to measure a temperature of the material containing long chained hydrocarbons after the material containing long chained hydrocarbons passing the first heat transmission portion 312. In various embodiments the material temperature sensor 44 is configured to measure a temperature of the material containing long chained hydrocarbons prior to and after the material containing long chained hydrocarbons passing the first heat transmission portion 312. In some of these embodiments the material temperature sensor 44 determines a temperature difference of the material containing long chained hydrocarbons from before passing the first heat transmission portion 312 and after passing the first heat transmission portion 312. In some of these embodiments the material temperature sensor 44 is configured to transmit a signal representative of the temperature of the material containing long chained hydrocarbons before passing the first heat transmission portion 312 and after passing the first heat transmission portion 312, and/or the temperature difference of the material containing long chained hydrocarbons before and after passing the first heat transmission portion 312.

The flow control member 40 is configured to operate the adjustable flow control valve 313a. In various embodiments the flow control member 40 is configured to operate the adjustable flow control valve 313a dependent on the signal representative of the temperature of the material containing long chained hydrocarbons and/or the signal representative of the temperature of the heating medium. In various embodiments the flow control member 40 is configured to operate the adjustable flow control valve 313a dependent on the signal representative of the temperature difference of the material containing long chained hydrocarbons before and after passing the first heat transmission portion 312 and/or dependent on the signal representative of the temperature difference of the heating medium before and after passing the first heat transmission portion 312.

In some embodiments the temperature adjusted line section 310b is provided with a flow sensor 46 detecting a throughput of heating medium through the temperature adjusted line section 310b and thus, through the first heat transmission portion 312. In further embodiments the temperature adjusted line section 310b is provided with a filter 48 for the heating medium.

In various embodiments the flow sensor 46 is configured to transmit a signal representative of the throughput to the first fluid control pump 311. In various embodiments the first flow control pump 311 and the flow sensor 46 are configured to provide a feedback control loop adjusting a constant throughput of heating medium through the temperature adjusted line section 310b. Consequently, by adjusting the adjustable flow control valve 313a, the temperature of the heating medium in the temperature adjusted line section 310b is adjusted. In the example of FIG. 3 with adjustments maintained constant unless otherwise specified, the temperature of the heating medium in the temperature adjusted line section 310b is primarily determined by the temperature of the heating medium in the flow control line section 310a passing from the heating fluid distribution line 32, the heating medium in the bypass line section 310d passing from the first heat transmission portion 312, and their mixing ratio as determined by the adjustable flow control valve 313a. The inventors realized that the flow control valve 313a is less disturbing for the pressures in the heating fluid distribution line 32 and thus for the distribution line pump 33.

When increasing the throughput of heating medium, for example by adjusting the first fluid control pump 311, the heating medium spends less time in the first heat transmission portion 312 and consequently cools down less. The heating medium in the bypass line section 310d thus has a higher temperature. Accordingly, to maintain the temperature of the heating medium in the temperature adjusted line section 310b the mixing ratio as determined by the adjustable flow control valve 313 is adapted. Particularly, the amount of the heating medium in the flow control line section 310a passing from the heating fluid distribution line 32 is reduced. Correspondingly, when decreasing the throughput of heating medium, for example by adjusting the first fluid control pump 311, the heating medium spends more time in the first heat transmission portion 312 and consequently cools down more, down to the temperature of the material containing long chained hydrocarbons at the inlet of the first heat transmission portion 312 “PM Inlet Temp”.

In various embodiments the flow control member 40 is configured to adjust the adjustable flow control valve 313a and the first fluid control pump 311. The temperature of the heating medium thus can be adjusted in a range between the temperature of the heating medium in the heating fluid distribution line 32 as provided by the heat source 31 and the temperature of the material containing long chained hydrocarbons. If the heating medium has the temperature of the material containing long chained hydrocarbons no thermal energy is conferred from the heating medium to the material containing long chained hydrocarbons. In various embodiments the flow control member 40 is configured to adjust the temperature of the heating medium in the temperature adjusted line section 310b to expose the material containing long chained hydrocarbons to a predetermined temperature of around 50 °C or less above the temperature of the material containing long chained hydrocarbons in a respective section of the first heat transmission portion 312, preferably less than 40 °C, more preferably less than 30 °C, more preferably less than 20 °C.

From the above it is clear that the temperature of the heating medium in the first heat transmission portion 312 cannot be lowered below the temperature of the material containing long chained hydrocarbons in the first heat transmission portion 312, unless the temperature of the heating medium is lower than the temperature of the material containing long chained hydrocarbons.

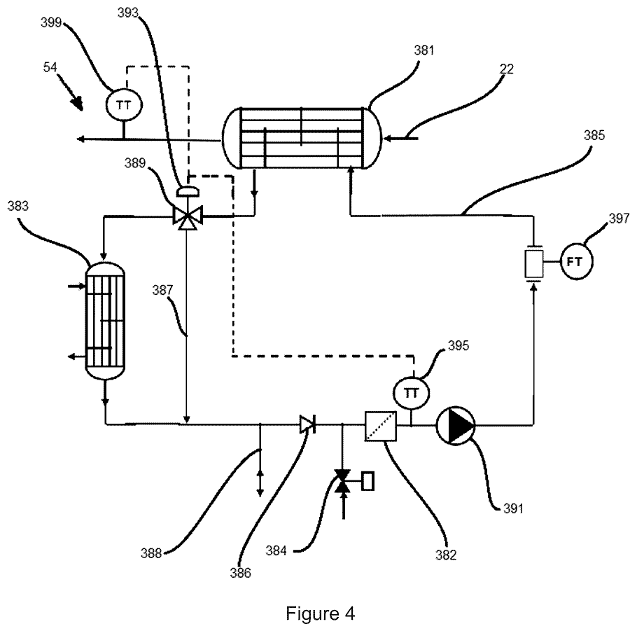

FIG. 4 discloses an embodiment of a heat transfer structure 54 operable particularly in conjunction with the partial condenser 21. In the depicted embodiment the heat transfer structure 54 comprises a primary heat sink 381 providing a flow path for a process fluid, particularly for the gas containing hydrocarbons in the condenser vessel 22, a secondary heat sink 383 providing a flow path for a cooling fluid, and a cooling circuit 385 for circulating a cooling medium through the primary heat sink 381 and the secondary heat sink 383. In various embodiments, the primary heat sink 381 corresponds to the cooling tube 23 of the partial condenser 21. In further embodiments the heat transfer structure is applied to a carbon discharge from the outlet for the heavy hydrocarbons and/or solid carbon discharge process fluid at the setting zone 28. For the carbon discharge, the heat transfer structure is configured to cool the carbon discharged from the setting zone 28. In various embodiments, each of the partial condenser 21 and to the carbon discharge are provided with a heat transfer structure according to the heat transfer structure 54 of FIG. 4. In the following, the heat transfer structure 54 will be primarily described in operation at the partial condenser 21. The structure and function for cooling heavy hydrocarbons and/or solid carbons exiting the setting zone 28 at the carbon discharge are substantially the same.

In operation, the cooling circuit 385 circulates the cooling medium through the primary heat sink 381 where the gas containing hydrocarbons in the condenser vessel 22 heats the cooling medium, the cooling circuit 385 then circulates the heated cooling medium through the secondary heat sink 383 where the cooling fluid cools the cooling medium, and the cooling circuit circulates the cooled cooling medium to the primary heat sink 381 where the cooling medium is heated by the gas containing hydrocarbons.

In various embodiments the heat transfer structure 54 comprises a cooling medium branch line 387 and a cooling circuit split valve 389. The cooling medium branch line 387 and the cooling circuit split valve 389 are configured to control a share of the cooling medium to selectively bypass the secondary heat sink 383. For example, the share of the cooling medium bypassing the secondary heat sink 383 is adjusted to adjust the temperature of the cooling medium. Particularly, if the share of the cooling medium bypassing the secondary heat sink 383 is increased, less of the cooling medium is cooled in the secondary heat sink 383 and the cooling medium cools down less. Consequently, the gas containing hydrocarbons is cooled down less. Particularly, if the share of the cooling medium bypassing the secondary heat sink 383 is decreased, more of the cooling medium is cooled in the secondary heat sink 383 and the cooling medium cools down more. Consequently, the gas containing hydrocarbons is cooled down more. In further embodiments a control valve in the cooling medium branch line 387 and/or in the line before the secondary heat sink 383 adjust the share of the cooling medium to selectively bypass the secondary heat sink 383.

In various embodiments the cooling circuit 385 comprises a cooling medium pump 391 configured to circulate the cooling medium in the cooling circuit 385. In various embodiments the cooling medium pump 391 is configured to selectively adjust a cooling medium flow. In various embodiments, the cooling circuit 385 comprises a cooling flow control member 393, a cooling medium temperature sensor 395, a cooling medium flow sensor 397 and a temperature sensor 399 for the gas containing hydrocarbons. In an application at the carbon discharge, the temperature sensor 399 senses the temperature of the heavy hydrocarbons and/or solid carbons exiting the setting zone 28.

In various embodiments the cooling medium temperature sensor 395 measures a temperature of the cooling medium in the cooling circuit 385. In various embodiments the cooling medium temperature sensor 395 measures a temperature of the cooling medium in the cooling circuit 385 after the cooling medium that passed the secondary heat sink 383 and the cooling medium that passed the cooling medium branch line 387 are combined.

In various embodiments, the temperature sensor 399 is configured to measure a temperature of the gas containing hydrocarbons close to an exit of the primary heat sink 381. Principally, temperature of the gas containing hydrocarbons close to an exit of the primary heat sink 381 is a temperature of the gas containing hydrocarbons after the heating fluid has passed the primary heat sink 381 and only underwent negligible following temperature variations. In various embodiments the cooling flow control member 393 adjusts a temperature of the gas containing hydrocarbons at the temperature sensor 399. In various embodiments the cooling flow control member 393 adjusts a temperature of the cooling medium at the cooling medium temperature sensor 395. In various embodiments the cooling flow control member 393 adjusts a temperature of the cooling medium at the cooling medium temperature sensor 395 and a temperature of the gas containing hydrocarbons at the temperature sensor 399 for the gas containing hydrocarbons.

In various embodiments the cooling medium flow sensor 397 is configured to measure a flow of the cooling medium in the cooling circuit 385 before entering the primary heat sink 381. In various embodiments the cooling medium flow sensor 397 measures the cooling medium passing the cooling circuit 385 in volume per unit time. In various embodiments the cooling medium flow sensor 397 measures the cooling medium passing the cooling circuit 385 in liters per second. In various embodiments the cooling medium pump 391 is configured to selectively adjust a specific cooling medium flow at the cooling medium flow sensor 397.

In various embodiments the cooling circuit 385 comprises a cooling medium filter 382 for removing contaminants from the cooling medium. Such contaminants may exemplarily originate from degradation in the cooling medium. In various embodiments the heat transfer structure 54 comprises a start-up heating supply 384 configured to supply heated cooling medium into the cooling circuit close to an operating temperature of the partial condenser 21 at nominal conditions. This allows to faster achieve an operating temperature of the partial condenser 21 as the cooling medium at start-up would otherwise have a temperature below its operating temperature and would cool the gas containing hydrocarbons during start-up unnecessarily. In various embodiments the start-up heating supply 384 is configured to provide heating fluid from the heating fluid distribution line 32 into the cooling circuit 385. In these embodiments the heating fluid is selected to have an operating range extending from the operating temperature of the partial condenser 21 and/or the carbon discharge to the operating temperature of all heating zones 1, 2, 3, 4, the reheating zone 6 and/or the reboiler section 29.

In various embodiments the cooling circuit 385 comprises a cooling medium check valve 386 preventing backflow due to the cooling medium pump 391 shutting off and/or due to the start-up heating supply 384 supplying cooling medium. In various embodiments the heat transfer structure 54 comprises a breathing line 388 in communication with the heating fluid distribution line 32 allowing for volume variations of the cooling medium in the cooling circuit 385 e.g. due to temperature changes or creation of bubbles if the cooling medium locally reaches or passes its boiling point. The breathing line 388 also allows selectively circulating heating fluid through the cooling circuit 385.

In various embodiments the cooling fluid is water or contains water. In various embodiments the cooling medium has a boiling point above the boiling point of the cooling fluid. In various embodiments the cooling medium is a thermal oil.

In various embodiments a process of operating the heating structure 11 and the heating fluid circuit 30 at nominal conditions is configured as follows:

In various embodiments the heat source heats up the heating fluid. In various embodiments the flare 37 burns gas to heat the heating fluid. The heating fluid distribution line 32 circulates the heated heating fluid to the heating sections 1, 2, 3, 4, 29. In various embodiments, the first branch line 310 of the first heating section 1 selectively circulates a share of the heated heating fluid through the first heat transmission portion 312. Particularly, the first heat transmission portion 312 transmits heat from the heating fluid to the molten long chained hydrocarbons in the first heating section 1. The first heating fluid control member 311, 313 adjusts a flow rate of the heating fluid through the first heat transmission portion 312 and accordingly adjusts the share of heating fluid passing the first branch line 310 of the first heating section 1. The flow rate of the heating fluid through the first heat transmission portion 312 adjusts the temperature of the molten long chained hydrocarbons at the first heating section 1. Particularly, the temperature of the heating fluid through the first heat transmission portion 312 determines the thermal energy conferred to the molten long chained hydrocarbons at the first heating section 1. In various embodiments, the first fluid control pump 311 of the first heating fluid control member adjusts a throughput of the heating fluid through the first heating section 1.

In various embodiments, the first fluid control valve 313 of the first heating fluid control member adjusts a throughput of the heating fluid through the first heating section 1. In various embodiments the first fluid control valve 313 adjusts a recirculation of heating fluid after passing the first heating section 1 in a manner that at least some of the heating fluid passes to the first fluid control pump 311 and the first heating section 1 without first passing to the heating fluid distribution line 32 and the heat source 31. That is, the heating fluid coming from the heating fluid distribution line 32 mixes with the heating fluid coming from the first heating section 1. As the heating fluid coming from the first heating section 1 has been cooled down by exposure to the molten long chained hydrocarbons, adjusting the mixing ratio of the heating fluid from the heating fluid distribution line 32 and from the first heating section 1 adjusts the temperature of the heating fluid circulating in the first heat transmission portion 312 of the first heating section 1. In this manner, the first fluid control valve 313 adjusts the temperature of the heating fluid in the first heat transmission portion 312 to thus provide the determined exposure temperature.

In embodiments wherein the temperature of the molten long chained hydrocarbons is above a minimum cracking temperature when entering the first heating section 1, the exposure temperature is determined to be around 50 °C or less above the temperature of the molten long chained hydrocarbons in a respective section of the first heat transmission portion 312, preferably less than 40 °C, more preferably less than 30 °C, more preferably less than 20 °C above the temperature of the molten long chained hydrocarbons.

In various embodiments wherein the temperature of the molten long chained hydrocarbons is below the minimum cracking temperature, the exposure temperature is determined to be close to or above the minimum cracking temperature. For example the exposure temperature is determined to be around 50 °C or less above the minimum cracking temperature, preferably less than 40 °C, more preferably less than 30 °C, more preferably less than 20 °C above the minimum cracking temperature. In further embodiments the temperature of the molten long chained hydrocarbons exiting the first heating section is measured to be around 50 °C or less above the minimum cracking temperature, the first fluid control valve 313 adjusts the mixing ratio of the heating fluid from the heating fluid distribution line 32 and from the first heating section 1 in a manner such that essentially only heating fluid from the heating fluid distribution line 32 passes to the first fluid control pump 311 and the first heating section 1.

In various embodiments wherein the temperature of the molten long chained hydrocarbons is above the minimum cracking temperature, there is usually a temperature drop between the heating fluid entering the first heat transmission portion 312 and the heating fluid exiting the first heat transmission portion 312. If the flow velocity of the heating fluid in the first heat transmission portion 312 is sufficiently high, this temperature drop is negligible for the above considerations. However, in various embodiments the flow velocity of the heating fluid in the first heat transmission portion 312 is so low that this temperature drop may be considered for the determination of the temperature of the heating fluid in the first heat transmission portion 312. In these cases, the temperature of the heating medium is determined such that in any section of the first heating section 1 the exposure temperature is determined to be within above limits. That is, in various embodiments the temperature of the heating fluid before passing the first heating section 1 is determined to be more than 50 °C above the temperature of the molten long chained hydrocarbons before passing the fourth heating section 4, as the heating fluid when passing into the first heating section 1 does not immediately contact the molten long chained hydrocarbons when passing into the first heating section 1.

In various embodiments, the second branch line 320 of the second heating section 2 selectively circulates a share of the heated heating fluid through the second heat transmission portion 322. Particularly, the second heat transmission portion 322 transmits heat from the heating fluid to the molten long chained hydrocarbons in the second heating section 2. The second heating fluid control member 321, 323 adjusts a flow rate of the heating fluid through the second heat transmission portion 322 and accordingly adjusts the share of heating fluid passing the second branch line 320 of the second heating section 2. The flow rate of the heating fluid through the second heat transmission portion 322 adjusts the temperature of the molten long chained hydrocarbons at the second heating section 2. Particularly, the temperature of the heating fluid through the second heat transmission portion 322 determines the thermal energy conferred to the molten long chained hydrocarbons at the second heating section 2. In various embodiments, the second fluid control pump 321 of the second heating fluid control member adjusts a throughput of the heating fluid through the second heating section 2.

In various embodiments, the second fluid control valve 323 of the second heating fluid control member adjusts a throughput of the heating fluid through the second heating section 2. In various embodiments the second fluid control valve 323 adjusts a recirculation of heating fluid after passing the second heating section 2 in a manner that at least some of the heating fluid passes to the second fluid control pump 321 and the second heating section 2 without first passing to the heating fluid distribution line 32 and the heat source 31. That is, the heating fluid coming from the heating fluid distribution line 32 mixes with the heating fluid coming from the second heating section 2. As the heating fluid coming from the second heating section 2 has been cooled down by exposure to the molten long chained hydrocarbons, adjusting the mixing ratio of the heating fluid from the heating fluid distribution line 32 and from the second heating section 2 adjusts the temperature of the heating fluid circulating in the second heat transmission portion 322 of the second heating section 2. In this manner, the second fluid control valve 323 adjusts the temperature of the heating fluid in the second heat transmission portion 322 to thus provide the determined exposure temperature.

In embodiments wherein the temperature of the molten long chained hydrocarbons is above a minimum cracking temperature when entering the second heating section 2, the exposure temperature is determined to be around 50 °C or less above the temperature of the molten long chained hydrocarbons in a respective section of the second heat transmission portion 322, preferably less than 40 °C, more preferably less than 30 °C, more preferably less than 20 °C above the temperature of the molten long chained hydrocarbons.

For example, if the temperature of the molten long chained hydrocarbons when entering the second heating section 2 is 300 °C, the exposure temperature is between 310 °C and 350 °C. The second fluid control valve 323 adjusts the mixing ratio of the heating fluid from the heating fluid distribution line 32 and from the second heating section 2 accordingly. Usually there is a temperature drop between the heating fluid entering the second heat transmission portion 322 and the heating fluid exiting the second heat transmission portion 322. If the flow velocity of the heating fluid in the second heat transmission portion 322 is sufficiently high, this temperature drop is negligible for the above considerations. However, in various embodiments the flow velocity of the heating fluid in the second heat transmission portion 322 is so low that this temperature drop may be considered for the determination of the temperature of the heating fluid in the second heat transmission portion 322. In these cases, the temperature of the heating medium is determined such that in any section of the second heating section 2 the exposure temperature is determined to be within above limits. That is, in various embodiments the temperature of the heating fluid before passing the second heating section 2 is determined to be more than 50 °C above the temperature of the molten long chained hydrocarbons before passing the second heating section 2.

In various embodiments, the third branch line 330 of the third heating section 3 selectively circulates a share of the heated heating fluid through the third heat transmission portion 332. Particularly, the third heat transmission portion 332 transmits heat from the heating fluid to the molten long chained hydrocarbons in the third heating section 3. The third heating fluid control member 331, 333 adjusts a flow rate of the heating fluid through the third heat transmission portion 332 and accordingly adjusts the share of heating fluid passing the third branch line 330 of the third heating section 3. The flow rate of the heating fluid through the third heat transmission portion 332 adjusts the temperature of the molten long chained hydrocarbons at the third heating section 3. Particularly, the temperature of the heating fluid through the third heat transmission portion 332 determines the thermal energy conferred to the molten long chained hydrocarbons at the third heating section 3. In various embodiments, the third fluid control pump 331 of the third heating fluid control member adjusts a throughput of the heating fluid through the third heating section 3.

In various embodiments, the third fluid control valve 333 of the third heating fluid control member adjusts a throughput of the heating fluid through the third heating section 3. In various embodiments the third fluid control valve 333 adjusts a recirculation of heating fluid after passing the third heating section 3 in a manner that at least some of the heating fluid passes to the third fluid control pump 331 and the third heating section 3 without first passing to the heating fluid distribution line 32 and the heat source 31. That is, the heating fluid coming from the heating fluid distribution line 32 mixes with the heating fluid coming from the third heating section 3. As the heating fluid coming from the third heating section 3 has been cooled down by exposure to the molten long chained hydrocarbons, adjusting the mixing ratio of the heating fluid from the heating fluid distribution line 32 and from the third heating section 3 adjusts the temperature of the heating fluid circulating in the third heat transmission portion 332 of the third heating section 3. In this manner, the third fluid control valve 333 adjusts the temperature of the heating fluid in the third heat transmission portion 332 to thus provide the determined exposure temperature.

When entering the third heating section 3, the temperature of the molten long chained hydrocarbons is usually above a minimum cracking temperature. In various embodiments, the exposure temperature is determined to be around 50 °C or less above the temperature of the molten long chained hydrocarbons in a respective section of the third heat transmission portion 332, preferably less than 40 °C, more preferably less than 30 °C, more preferably less than 20 °C above the temperature of the molten long chained hydrocarbons.

For example, if the temperature of the molten long chained hydrocarbons when entering the third heating section 3 is 330 °C, the exposure temperature is between 340 °C and 380 °C. The third fluid control valve 333 adjusts the mixing ratio of the heating fluid from the heating fluid distribution line 32 and from the third heating section 3 accordingly. Usually there is a temperature drop between the heating fluid entering the third heat transmission portion 332 and the heating fluid exiting the third heat transmission portion 332. If the flow velocity of the heating fluid in the third heat transmission portion 332 is sufficiently high, this temperature drop is negligible for the above considerations. However, in various embodiments the flow velocity of the heating fluid in the third heat transmission portion 332 is so low that this temperature drop may be considered for the determination of the temperature of the heating fluid in the third heat transmission portion 332. In these cases, the temperature of the heating medium is determined such that in any section of the third heating section 3 the exposure temperature is determined to be within above limits. That is, in various embodiments the temperature of the heating fluid before passing the third heating section 3 is determined to be more than 50 °C above the temperature of the molten long chained hydrocarbons before passing the third heating section 3.

In various embodiments, the fourth branch line 340 of the fourth heating section 4 selectively circulates a share of the heated heating fluid through the fourth heat transmission portion 342. Particularly, the fourth heat transmission portion 342 transmits heat from the heating fluid to the molten long chained hydrocarbons in the fourth heating section 4. The fourth heating fluid control member 341, 343 adjusts a flow rate of the heating fluid through the fourth heat transmission portion 342 and accordingly adjusts the share of heating fluid passing the fourth branch line 340 of the fourth heating section 4. The flow rate of the heating fluid through the fourth heat transmission portion 342 adjusts the temperature of the molten long chained hydrocarbons at the fourth heating section 4. Particularly, the temperature of the heating fluid through the fourth heat transmission portion 342 determines the thermal energy conferred to the molten long chained hydrocarbons at the fourth heating section 4. In various embodiments, the fourth fluid control pump 341 of the fourth heating fluid control member adjusts a throughput of the heating fluid through the fourth heating section 4.

In various embodiments, the fourth fluid control valve 343 of the fourth heating fluid control member adjusts a throughput of the heating fluid through the fourth heating section 4. In various embodiments the fourth fluid control valve 343 adjusts a recirculation of heating fluid after passing the fourth heating section 4 in a manner that at least some of the heating fluid passes to the fourth fluid control pump 341 and the fourth heating section 4 without first passing to the heating fluid distribution line 32 and the heat source 31. That is, the heating fluid coming from the heating fluid distribution line 32 mixes with the heating fluid coming from the fourth heating section 4. As the heating fluid coming from the fourth heating section 4 has been cooled down by exposure to the molten long chained hydrocarbons, adjusting the mixing ratio of the heating fluid from the heating fluid distribution line 32 and from the fourth heating section 4 adjusts the temperature of the heating fluid circulating in the fourth heat transmission portion 342 of the fourth heating section 4. In this manner, the fourth fluid control valve 343 adjusts the temperature of the heating fluid in the fourth heat transmission portion 342 to thus provide the determined exposure temperature.

When entering the fourth heating section 4, the temperature of the molten long chained hydrocarbons is usually above a minimum cracking temperature. In various embodiments, the exposure temperature is determined to be around 50 °C or less above the temperature of the molten long chained hydrocarbons in a respective section of the fourth heat transmission portion 342, preferably less than 40 °C, more preferably less than 30 °C, more preferably less than 20 °C above the temperature of the molten long chained hydrocarbons.

For example, if the temperature of the molten long chained hydrocarbons when entering the fourth heating section 4 is 370 °C, the exposure temperature is between 390 °C and 420 °C. The fourth fluid control valve 343 adjusts the mixing ratio of the heating fluid from the heating fluid distribution line 32 and from the fourth heating section 4 accordingly. Usually there is a temperature drop between the heating fluid entering the fourth heat transmission portion 342 and the heating fluid exiting the fourth heat transmission portion 342. If the flow velocity of the heating fluid in the fourth heat transmission portion 342 is sufficiently high, this temperature drop is negligible for the above considerations. However, in various embodiments the flow velocity of the heating fluid in the fourth heat transmission portion 342 is so low that this temperature drop may be considered for the determination of the temperature of the heating fluid in the fourth heat transmission portion 342. In these cases, the temperature of the heating medium is determined such that in any section of the fourth heating section 4 the exposure temperature is determined to be within above limits. That is, in various embodiments the temperature of the heating fluid before passing the fourth heating section 4 is determined to be more than 50 °C above the temperature of the molten long chained hydrocarbons before passing the fourth heating section 4.

In various embodiments, the reboiler branch line 370 of the reboiler section 29 selectively circulates a share of the heated heating fluid through the reboiler heat transmission portion 372. Particularly, the reboiler heat transmission portion 372 transmits heat from the heating fluid to liquid coming from the partial condenser 21 which liquid was condensed from the gas in the partial condenser 21. The reboiler heating fluid control member 371, 373 adjusts a flow rate of the heating fluid through the reboiler heat transmission portion 372 and accordingly adjusts the share of heating fluid passing the reboiler branch line 370 of the reboiler section 29. The flow rate of the heating fluid through the reboiler heat transmission portion 372 adjusts the temperature of the liquid coming from the partial condenser 21. Particularly, the temperature of the heating fluid through the reboiler heat transmission portion 372 determines the thermal energy conferred to the gas coming from the partial condenser 21. In various embodiments, the reboiler fluid control pump 371 of the reboiler heating fluid control member adjusts a throughput of the heating fluid through the reboiler section 29.

In various embodiments, the reboiler fluid control valve 373 of the reboiler heating fluid control member adjusts a throughput of the heating fluid through the reboiler section 29. In various embodiments the reboiler fluid control valve 373 adjusts a recirculation of heating fluid after passing the reboiler section 29 in a manner that at least some of the heating fluid passes to the reboiler fluid control pump 371 and the reboiler section 29 without first passing to the heating fluid distribution line 32 and the heat source 31. That is, the heating fluid coming from the heating fluid distribution line 32 mixes with the heating fluid coming from the reboiler section 29. As the heating fluid coming from the reboiler section 29 has been cooled down by exposure to the liquid coming from the partial condenser 21, adjusting the mixing ratio of the heating fluid from the heating fluid distribution line 32 and from the reboiler section 29 adjusts the temperature of the heating fluid circulating in the reboiler heat transmission portion 372 of the reboiler section 29. In this manner, the reboiler fluid control valve 373 adjusts the temperature of the heating fluid in the reboiler heat transmission portion 372 to thus provide the determined exposure temperature.

When entering the reboiler section 29, the hydrocarbons in the gas coming from the partial condenser 21 are usually sufficiently cracked. The reboiler section 29 adjusts the temperature of the gas to allow for further separation in a fractionating column.

The reboiler fluid control valve 373 adjusts the mixing ratio of the heating fluid from the heating fluid distribution line 32 and from the reboiler section 29 accordingly. Usually there is a temperature drop between the heating fluid entering the reboiler heat transmission portion 372 and the heating fluid exiting the reboiler heat transmission portion 372. If the flow velocity of the heating fluid in the reboiler heat transmission portion 372 is sufficiently high, this temperature drop is negligible for the above considerations. However, in various embodiments the flow velocity of the heating fluid in the reboiler heat transmission portion 372 is so low that this temperature drop may be considered for the determination of the temperature of the heating fluid in the reboiler heat transmission portion 372.

The reheating branch line 360 of the reheating zone 6 passes heating fluid through the reheating heat transmission portion 362. The reheating heat transmission portion 362 provides heat transmission from the heating fluid to the molten long chained hydrocarbons in the reheating zone 6 piped from the separation structure 12. The reheating fluid control member 363 adjusts a flow rate of the heating fluid through the reheating heat transmission portion 362. In various embodiments, the reheating fluid control valve 363 adjusts a throughput of the heating fluid through the reheating zone 6. In various embodiments the temperature of the reheating heat transmission portion 362 is adjusted by the heat source 31.

During a start-up process, each of the first to fourth heating fluid control members 311, 313, 321, 323, 331, 333, 341, 343 adjusts a flow rate of the heating fluid through the first to fourth heat transmission portions 312, 322, 332, 342 such that the exposure temperatures are around 50 °C or less above the temperature of the molten long chained hydrocarbons in the respective sections of the first to fourth heat transmission portion 312, 322, 332, 342, preferably less than 40 °C, more preferably less than 30 °C, more preferably less than 20 °C above the temperature of the molten long chained hydrocarbons in the respective sections of the first to fourth heat transmission portions 312, 322, 332, 342. In various embodiments, during start-up the start-up heating supply 384 supplies heated cooling medium into the cooling circuit close to an operating temperature of the heating fluid at nominal conditions. The heat source can thus operate at nominal conditions from the start while the first to fourth heating fluid control members make sure that the exposure temperatures remain in the desired ranges.

In a turn-down process, the cooling circuit passes the heating fluid or a cooling medium along the heat sink such that the heating fluid is cooled down quickly and the time for cooling down is reduced. In this way the down-time for maintenance or for shut-down in general is reduced as well. In further embodiments, the cooling loop also allows for cooling down in a controlled gradual manner. For some fluids like hot char this avoids clogging and solidification.

1. A device for heating molten long chained hydrocarbons in a continuous process, the device comprising:
a heating fluid circuit having a heat source for heating a heating fluid, and a heating fluid distribution line for circulating the heating fluid;
a first heating section arranged to heat molten long chained hydrocarbons to a first temperature; and
a second heating section arranged to heat molten long chained hydrocarbons to a second temperature;
wherein the first and second heating sections are arranged to receive heating fluid through the heating fluid distribution line; and
wherein the first heating section is arranged to adjust heating fluid circulation through the first heating section in a manner adjusting the first temperature.

2. The device of claim 1, wherein the second heating section is arranged to adjust heating fluid circulation through the second heating section in a manner adjusting the second temperature.

3. The device of claim 1, wherein the first and second heating sections are arranged to pass molten long chained hydrocarbons from the first heating section to the second heating section.

4. The device of claim 1, wherein the second temperature is configured above the first temperature, and/or wherein the second temperature and/or the first temperature are above a cracking temperature of the molten long chained hydrocarbons.

5. The device of claim 1, comprising a third heating section arranged to heat molten long chained hydrocarbons to a third temperature and to receive heating fluid through the heating fluid distribution line, wherein the molten long chained hydrocarbons are passed from the second heating section to the third heating section, and wherein the third temperature is above the second temperature.

6. The device of claim 1, wherein at least one of the heating sections comprises a heat transmission portion and a heating fluid control member, wherein the heat transmission portion is configured to provide heat transmission from the heating fluid to the molten long chained hydrocarbons in the at least one of the heating sections, wherein the heating fluid control member is configured to mix heating fluid from the heat transmission portion and from the heating fluid distribution line to adjust a temperature of the mixed heating fluid and to provide the mixed heating fluid to the heat transmission portion.

7. The device of claim 6, wherein the heating fluid control member comprises a fluid control pump to adjust a heating fluid flow through the heat transmission portion and/or a fluid control valve to adjust a share of heating fluid from the heating fluid distribution line in the mixed heating fluid provided to the heat transmission portion.

8. The device of claim 1, comprising a cooling structure, the cooling structure comprising a heat sink for cooling a heating medium during passage, and a split valve configured to control a share of the heating medium to selectively bypass the heat sink, wherein the heating medium is the heating fluid or a cooling medium.

9. The device of claim 1, comprising a heat transfer structure wherein the heat transfer structure comprises a primary heat sink providing a flow path for a process fluid, a secondary heat sink providing a flow path for a cooling fluid, and a cooling circuit for circulating a cooling medium through the primary heat sink and the secondary heat sink to transfer heat from the process fluid at the primary heat sink to the cooling fluid at the secondary heat sink, and wherein the cooling circuit preferably comprises a start-up heating supply configured to supply the heating fluid as a cooling medium into the cooling circuit.

10. The device of claim 9, wherein the heat transfer structure comprises a cooling medium branch line and a cooling circuit valve, the cooling medium branch line and the cooling circuit valve being configured to control a share of the cooling medium to selectively bypass the secondary heat sink, wherein the share of the cooling medium bypassing the secondary heat sink preferably is adjusted to adjust the temperature of the cooling medium and/or the process fluid.

11. A method for heating molten long chained hydrocarbons in a continuous process, the method comprising:
heating a heating fluid;
circulating the heating fluid;
in a first heating section, heating molten long chained hydrocarbons to a first temperature;
in a second heating section, heating the molten long chained hydrocarbons to a second temperature;
wherein the first and second heating sections are arranged to receive heating fluid through the heating fluid distribution line; and
wherein the first heating section adjusts the heating fluid circulation through the first heating section in a manner adjusting the first temperature.

12. The method of claim 11, wherein the second heating section adjusts the heating fluid circulation through the second heating section in a manner adjusting the second temperature, and wherein the molten long chained hydrocarbons pass from the first heating section to the second heating section.

13. The method of claim 11, wherein the second temperature is configured above the first temperature, and wherein the second temperature and preferably the first temperature are above a cracking temperature of the molten long chained hydrocarbons.

14. The method of claim 11, wherein at least one of the heating sections comprises a heat transmission portion and a heating fluid control member, wherein the heat transmission portion provides heat transmission from the heating fluid to the molten long chained hydrocarbons in the at least one of the heating sections, wherein the heating fluid control member mixes heating fluid from the heat transmission portion and from the heating fluid distribution line to adjust a temperature of the mixed heating fluid and provides the mixed heating fluid to the heat transmission portion.

15. The method of claim 11, wherein the molten long chained hydrocarbons are passed from the second heating section to a third heating section, the third heating section receives heating fluid through the heating fluid distribution line and heats the molten long chained hydrocarbons to a third temperature, and wherein the third temperature is above the second temperature.
